(19) United States
(12) Patent Application Publication
(10) Pub. No.: US 2007/0147612 A1
(43) Pub. Date: Jun. 28, 2007

(54) Deriving cryptographic keys

(76) Inventors: Simon Forrest, Dundee (GB); Gary Ross, Edinburgh (GB)

Correspondence Address: MICHAEL CHAN;NCR CORPORATION, 1700 SOUTH PATTERSON BLVD, DAYTON, OH, 45479-0001, US

(21) Appl. No.: 11/315,890

(22) Filed: Dec. 22, 2005

(51) Int. Cl. H04K 1/00

(52) U.S. Cl. 380/255

(57) ABSTRACT

A method of deriving a cryptographic key from a token. The method comprises ascertaining an attribute of an emission from the token; processing the attribute to generate a seed; and deriving a cryptographic key from the seed. The attribute may be luminescence intensity values of a token. The method may be implemented by a self-service terminal, such as an automated teller machine.

### BACKGROUND

The present invention relates to deriving cryptographic keys. Cryptographic keys are used with a cryptographic algorithm to encrypt and decrypt information, for example, to secure the use and transmission of that information. Cryptographic keys are commonly used in systems that require high electronic security, such as automated teller machines (ATMs), which encrypt a personal identification number (PIN) entered by a customer via an encrypting keypad (EKP) module.

A typical EKP module is both tamper-resistant (it is difficult to tamper with) and tamper-responsive (it destroys any stored cryptographic keys in the event of the EKP being opened). An EKP module comprises: a housing through which a keypad protrudes; and an encryption unit located within the housing. When a user enters his or her PIN at an ATM via the EKP, the EKP uses a stored cryptographic key and algorithm, such as Triple Data Encryption Standard (Triple DES), to encrypt the entered digits. The encrypted digits are transmitted from the EKP to a controller within the ATM, which appends account information and transaction details to form a PINblock. The PINblock is then forwarded to an ATM switch, which routes the PINblock to an authorization center. The authorization center then parses the PINblock, decrypts the encrypted PIN to verify identity of the user, and authorizes the transaction.

Currently, distributing cryptographic keys for EKPs is manpower intensive because multiple service personnel are commonly used to enter a key at a given ATM, each one knowing only a portion of the overall key to maintain key secrecy.

### SUMMARY

In general, the present invention relates to a method and apparatus for deriving a cryptographic component (such as a key) using an attribute of a material.

According to a first aspect of the present invention there is provided a method of deriving a cryptographic key from a token comprising: ascertaining an attribute of an emission from the token; processing the attribute to generate a seed; and deriving a cryptographic key from the seed.

The method may further comprise normalizing the attribute of the emission from the token prior to processing the attribute to generate a seed. The attribute may be luminescence intensity at each of a plurality of wavelengths, and processing the attribute to generate a seed may include mapping each luminescence intensity to a corresponding binary code.

Ascertaining an attribute of an emission from the token may comprise exciting the token; and detecting luminescence from the material in response to the excitation. The attribute may be obtained from the decay rate of the resulting emission.

The token may be an identifier carried by an authorized person. The identifier may be in the form of a card, such as a magnetic stripe card, an integrated circuit card, or plain card (similar to a business card). The token may be formed from luminescent material, or it may incorporate luminescent material therein. In one embodiment, the token includes a secure tag area comprising luminescent tags mounted onto the card, or incorporated therein (for example by lamination). Where luminescent tags are mounted onto a card, the tags may be mounted by clear adhesive. Alternatively, the token may not be in card-form; the token may comprise a common object (such as a button, a ring or such like) that is either formed (in part or in whole) from a luminescent material or that includes luminescent material (such as luminescent tags) in that object.

According to a second aspect of the present invention there is provided an apparatus for deriving a cryptographic key comprising: a reader adapted to ascertain an attribute of an emission from a token; and a processor coupled to the reader and operable to: (i) process the attribute to generate a seed; and (ii) derive a cryptographic key from the seed.

The processor may be operable to process the attribute to generate a seed by: normalizing the attribute; and applying an algorithm to the normalized attribute to map the normalized attribute to a sequence of bits.

The attribute may be luminescence across a wavelength range, so that the attribute comprises a plurality of intensity values, one value for each wavelength of interest.

The apparatus for deriving a cryptographic key may be incorporated into a self-service terminal such as an ATM. In particular, the apparatus may be incorporated into an encrypting keypad.

According to a third aspect of the invention there is provided a method of deriving a cryptographic key, the method comprising: ascertaining an attribute of an emission from a material; and processing the attribute to derive a cryptographic component. The cryptographic component may be a cryptographic key, a hashing algorithm, or such like. Processing the attribute may include: normalizing the attribute; and applying a function to the normalized attribute to derive the cryptographic key. The function may be an algorithm, a numerical method, an artificial intelligence system, or such like.

According to a fourth aspect of the present invention there is provided a method of deriving a cryptographic key including: ascertaining an attribute of an emission from a material; and applying an algorithm to the attribute to derive the cryptographic key.

The method may further include: normalizing the attribute of the emission; and applying the algorithm to the normalized attribute to derive the cryptographic key.

In some embodiments ascertaining an attribute of the emission further includes: optically exciting the material thereby resulting in an emission from the material; and detecting an attribute of the emission.

The attribute of an emission may be luminescence. The luminescence may be stimulated by electromagnetic radiation (photoluminescence), a chemical reaction (chemoluminescence), temperature (thermoluminescence), a biological process (bioluminescence), or such like.

The luminescence may be processed to produce a normalized data set. Processing the luminescence to produce a normalized data set has the advantage that slight variations in luminescence can be compensated so that a reproducible data set is always produced. Processing the luminescence may include normalizing luminescence intensity, ascertaining one or more ratios of a luminescence intensity at one wavelength to a luminescence intensity at another wavelength, and such like.

An attribute of an emission from a token includes, but is not restricted to, the luminescence intensity. The attribute of an emission from a token may refer to aspects of emission from a token that are unique to that token. These aspects may include one or more of: presence or absence of emission at one or more wavelengths; presence or absence of a peak in emission at one or more wavelengths; the number of emission peaks within all or a portion of the electromagnetic spectrum comprising, for example, ultraviolet radiation to infrared radiation (e.g., approximately 10 nm to 1 mm); rate of change of emission versus wavelength, and additional derivatives thereof; rate of change of emission versus time, and additional derivatives thereof; absolute or relative intensity of emission at one or more wavelengths; presence or absence of regions of the electromagnetic spectrum, for example ultraviolet radiation to infrared radiation, in which emission is above a predetermined absolute or relative intensity; presence or absence of regions of the electromagnetic spectrum, for example ultraviolet radiation to infrared radiation, in which emission is below a predetermined absolute or relative intensity; ratio of an intensity of one emission peak to an intensity of another emission peak or other emission peaks; the shape of an emission peak; the width of an emission peak; or such like.

According to a fifth aspect of the present invention there is provided an apparatus for deriving a cryptographic key which includes: a reader adapted to ascertain an attribute of an emission from a material; and a processor operatively connected to the reader and adapted to apply an algorithm to the attribute to derive the cryptographic key.

The processor may be further operative to normalize the attribute of the emission from the material, and apply the algorithm to the normalized attribute to derive the cryptographic key.

The reader may also include: a light source adapted to illuminate the material; and a detector adapted to detect an attribute of the resultant emission from the material.

According to a sixth aspect of the invention there is provided a self-service terminal incorporating an encrypting keypad, the terminal including a reader adapted to ascertain an attribute of an emission from a token; and a processor coupled to the reader and operable to: (i) process the attribute to generate a seed; and (ii) derive a cryptographic key from the seed.

The self-service terminal may be an ATM.

According to a seventh aspect of the present invention there is provided a cryptographic keypad device, the device comprising: a keypad for allowing a user to enter data; a housing for receiving a token; a detector aligned with the housing to ascertain an attribute of an emission from a token located within the housing; and a processor coupled to the detector and also coupled to a memory for storing at least one of a cryptographic key and a cryptographic algorithm, the processor being operable to process the ascertained attribute to identify a cryptographic key or cryptographic algorithm stored within the memory for use in encrypting entered data.

By virtue of this aspect of the invention, a token (such as a card, memory stick, or such like) must be present in the keypad device to enable the cryptographic function of the device. This has the advantage that if the token is not present, the device will not function.

Various other features will become apparent from the following specific description, which is given by way of example, with reference to the accompanying drawings.

### BRIEF DESCRIPTION OF THE DRAWINGS

FIG. 1 illustrates a schematic view of a SST in the form of an ATM according to one embodiment of the present invention;

FIG. 2 is a block diagram of an ATM network including the ATM of FIG. 1;

FIGS. 3a to 3c are three different diagrams of a module (the EKP module) of the ATM of FIG. 1;

FIG. 4 is a pictorial view of a card for use with the EKP module of FIGS. 3a to 3c; and

FIG. 5 is a flowchart illustrating steps involved in deriving a cryptographic key using the EKP of FIGS. 3a to 3c.

### DETAILED DESCRIPTION

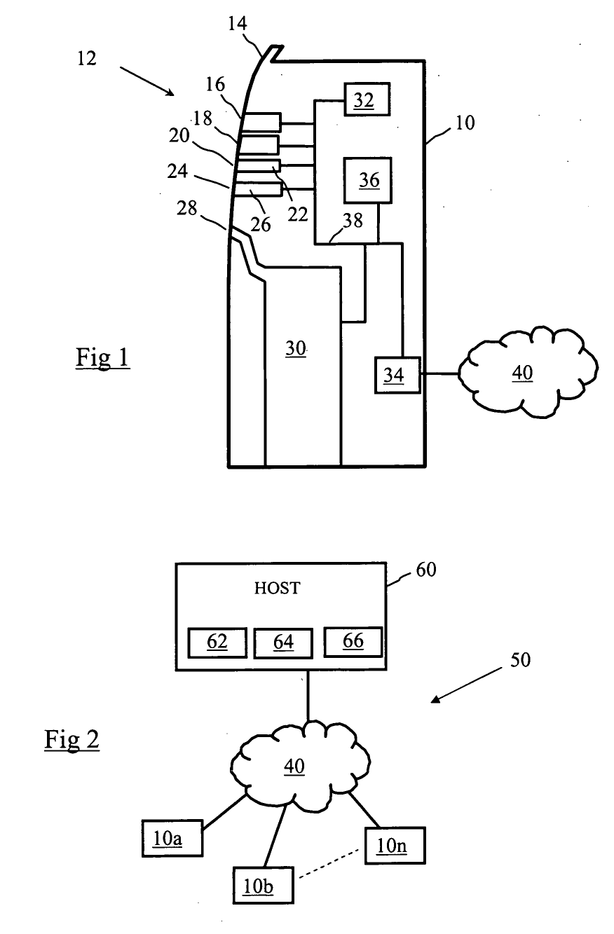

Reference is first made to FIG. 1, which is a cross-sectional view of a self-service terminal (SST) 10 in the form of an ATM according to one embodiment of the present invention. The ATM 10 includes a user interface 12 for input of information to, and output of information from, the ATM 10. The user interface 12 comprises an openable fascia 14 having apertures aligning with modules within the ATM 10. A display aperture aligns with a display module 16 for presenting transaction information; a keypad aperture aligns with an input device in the form of an encrypting keypad (EKP) module 18; and a plurality of media input and output slots are aligned with respective media input and output modules located behind the molded fascia 14. These include a magnetic card entry/exit slot 20 that aligns with a magnetic card reader/writer (MCRW) module 22, a receipt printer slot 24 that aligns with a receipt printer module 26, and a cash dispense slot 28 that aligns with a cash dispenser module 30. These modules can be accessed by opening the fascia 14.

Reference is now also made to FIG. 2, which is a block diagram of a system 50 of ATMs 10a-n, each of these ATMs being identical to the ATM 10 of FIG. 1.

The ATM 10 further includes an internal journal printer module 32 for creating a record of all transactions executed by the ATM 10, and a network communication module 34 for communicating with a remote host 60 (FIG. 2) via a network 62. The remote host validates account information, authorizes transactions, and downloads software and data to the ATMs 10 connected thereto. The ATM 10 also includes a controller module 36 for controlling operation of the various modules, and a bus 38 for interconnecting all of the modules and conveying data therebetween.

The host 60 includes an authorization facility 62 for authorizing transactions, a back-office facility 64, and a software repository 66 for storing software programs for distribution to the ATMs 10a-n via the network 40.

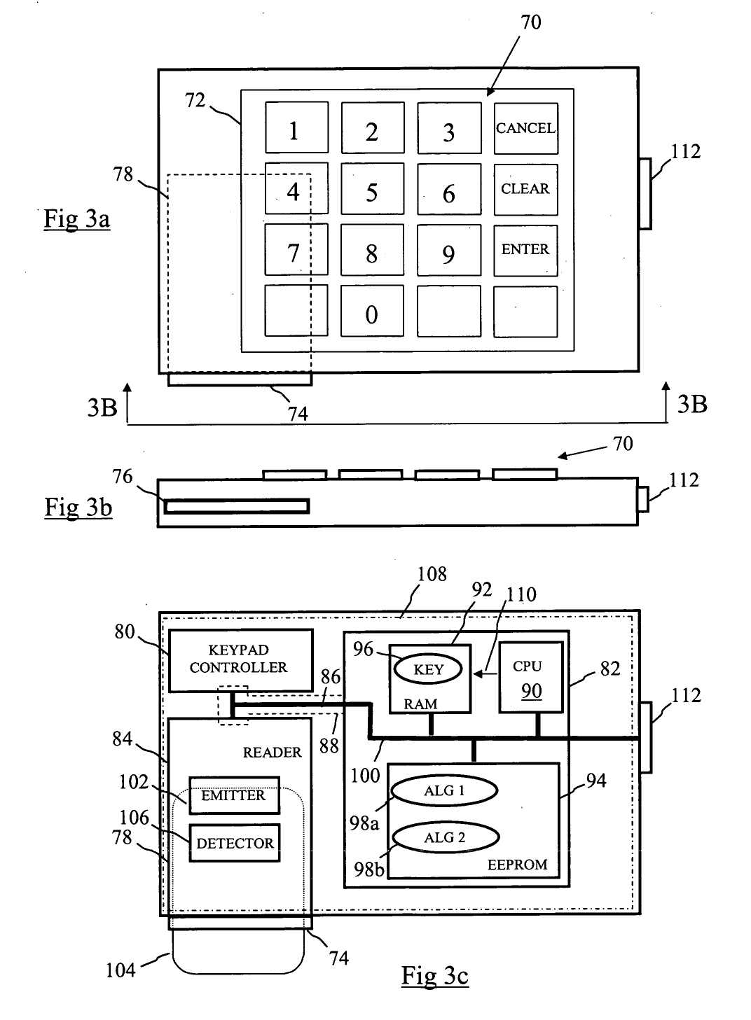

Reference is now made to FIGS. 3a to 3c, which show the EKP module 18 in more detail. FIG. 3a is a pictorial view of the EKP module 18, having a keypad 70 including sixteen individual keys, each key having either a digit (with one of the numbers from 0 to 9) etched or printed thereon, words such as “Cancel,” “Clear”, and “Enter,” or such like, etched or printed thereon, or left blank. This type of keypad is also referred to as a PIN pad. The keypad 70 protrudes from an upper surface of the EKP module 18. When closed, the ATM fascia 14 keypad aperture (not shown) aligns with a keypad perimeter 72 so that only the PIN pad 70 (of the EKP module 18) is visible to an ATM customer through the fascia keypad aperture. FIG. 3b is a pictorial side view of the EKP module 18 in the direction of arrows 3B-3B on FIG. 3a. The EKP module 18 also includes a throat 74 defining a card receiving aperture 76 (FIG. 3b) leading to a guidance housing 78 into which an authorized person may insert a cryptographic card.

FIG. 3b is a schematic diagram of the components within the EKP module 18. These components include: a keypad controller 80 for detecting what keys are depressed on the keypad 70; an encryption unit 82, and a reader 84. Data from the keypad 70 is transmitted to the encryption unit 82 via an internal tamper-detecting bus 86 enveloped by a membrane shield 88 that detects any attempt to access the data lines in the bus 86 covered by the shield 88.

The encryption unit 82 includes a processor 90, volatile memory 92 in the form of random access memory (RAM), and non-volatile memory 94 in the form of electrically erasable programmable read only memory (EEPROM). The RAM 92 stores a cryptographic key 96. The EEPROM 94 stores at least one algorithm 98a (PIN encryption algorithm 98a) for encrypting information entered via keypad 70 using the cryptographic key 96, and one algorithm 98b (key deriving algorithm 98b) for deriving a new cryptographic key. The processor 90, the RAM 92, and the EEPROM 94 communicate via an internal bus 100.

The reader 84 includes an emitter 102 for exciting a token (in the form of a card) 104 (shown partially inserted in FIG. 3c) by illuminating the card 104, and a detector 106 for detecting emission from the card 102 in response to the illumination. The reader 84 communicates with the encryption unit 82 via the tamper-detecting bus 86.

The EKP module 18 also includes a tamper-detecting membrane 108 for detecting any attempt to open or otherwise access the EKP module 18. In addition, the encryption unit 82 includes an erase line 110 coupled to the RAM 92. The EKP module 18 is tamper-responsive, so that if any of the tamper-detecting mechanisms (the tamper-detecting bus 86 and the tamper-detecting membrane 108) detects a breach, then the cryptographic processor 90 activates the erase line 110 to delete the cryptographic key 96 from the RAM 92.

In normal operation the EKP module 18 outputs encrypted data to the ATM controller module 36 via an output port 112 in the form of a USB port.

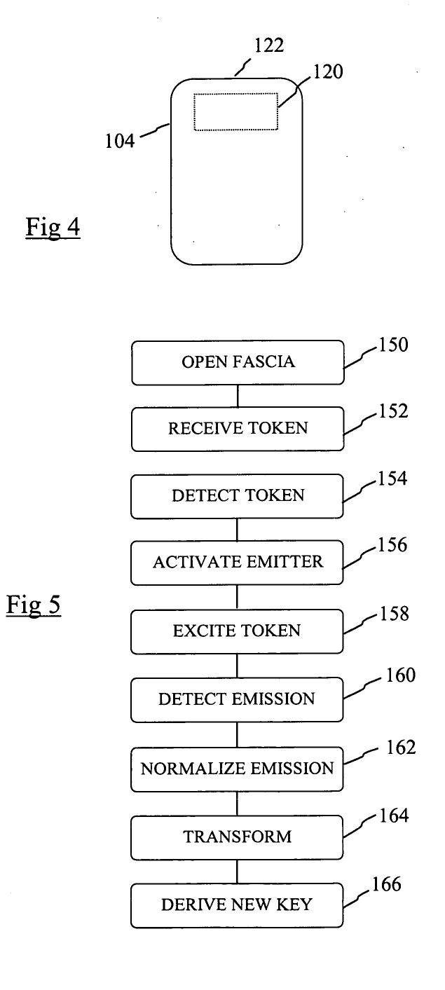

Reference is now made to FIG. 4, which illustrates the card 104 in more detail. The card 104 includes a tag area 120 which comprises a plurality of microscopic secure tags mounted on the card by clear adhesive. The microscopic secure tags comprise a borosilicate glass dopes with rare earth ions, as described in US patent application number 2004/0262547, entitled “Security Labelling,” and US patent application number 2005/0143249, entitled “Security Labels which are Difficult to Counterfeit”, both of which are incorporated herein by reference.

When an owner of the ATM system 50 wishes to replace the cryptographic key 96 on each ATM 10 with a new cryptographic key, the owner instructs one of the ATM service personnel (referred to hereinafter as a servicer) to take the card 104 to each ATM 10. The card 104 has been prepared so that the ATM system 50 knows what the new cryptographic key will be (so that it can decrypt the PIN at the remote host 60). Once the ATMs 10 have been updated with a new cryptographic key, the ATM owner will update the authorization facility 62 to install the new cryptographic key therein.

The process for loading a new cryptographic key is illustrated in FIG. 5, which is a flowchart illustrating the steps involved. When the servicer arrives at the ATM, he or she unlocks and then opens the fascia 14 (step 150) to get access to the modules mounted within the ATM. By opening the fascia 14, the servicer can access the throat 74 (which is not visible to an ATM customer when the fascia 14 is closed) and insert the card 104 into the card receiving aperture 76 (step 152). When the card 104 is fully inserted, a leading edge 122 of the card 104 closes a microswitch (not shown) within the reader 84, which indicates that the card 104 is fully inserted (step 154). The microswitch is positioned so that when the microswitch is closed by the leading edge 122, the tag area 120 is in registration with the emitter 102. In response to detecting the microswitch closing, the reader 84 activates the emitter 102 (step 156), which emits a pulse of light to radiate the tag area 120. This pulse of light excites the secure tags in the tag area (step 158). In response to this excitation, the secure tags luminesce. The secure tags include rare earth ions, which have relatively long luminescence lifetimes, so the luminescence can still be detected once the excitation has ceased.

Once the excitation has ceased, the detector 106 is activated and detects luminescence from the secure tags (step 160). The detector 106 includes a CMOS imager having forty different elements and a diffraction grating (or prism) for splitting incident luminescence spatially based on its wavelength. By accurately aligning the CMOS imager and the diffraction grating, the CMOS imager measures luminescence intensity in increments of ten nanometers of wavelength from 400 nm to 790 nm. To state this another way, a luminescence spectrum is sampled at every ten nanometers between 400 and 790 nm. Each CMOS element corresponds to one sampled wavelength, so that the forty CMOS elements cover the entire spectrum from 400 nm to 790 nm in 10 nm increments. Thus, the CMOS imager produces forty measurement points.

The luminescence measured from the secure tags is an attribute of the card 104, and the EKP module 18 can use this attribute of the card 104 to generate a seed for deriving a new cryptographic key.

To generate a seed, the EKP module 18 first processes the detected luminescence to normalize the luminescence spectrum (step 162), that is, to normalize the intensity measurements at each of the forty measurement points. The luminescence is normalized by selecting a datum point (one of the forty points) and scaling the measured intensity at each of the forty measurement points relative to the measured intensity at the selected datum point. This step is required because the absolute values of luminescence intensity are arbitrary and change between measurements, but the relative values (that is, the intensity of one peak compared with the intensity of another peak on the same luminescence spectrum) is constant. Normalizing a luminescence spectrum using a datum point from that spectrum ensures that the results are reproducible.

Once the luminescence spectrum (which is the intensities at the forty measurement points) has been normalized, the normalized intensity measurements are transformed (step 164) to produce a sequence of bits that can be used as a seed for deriving a new key.

The transformation process involves mapping each of the normalized intensity measurements to one of eight intensity levels, using digitization error correction to take account of boundary problems (that is, when a scaled intensity measurement is at the boundary between two adjacent intensity levels). Each of the eight intensity levels is assigned a unique sequence of three bits (binary coding of eight different levels). Measuring a luminescence spectrum as described above produces a first series of forty mapped intensities, each mapped intensity having a value between one and eight. Thus, a sequence of 120 bits is produced from the forty measurement points. This sequence of 120 bits can be used a seed from which a new cryptographic key can be derived.

Digitization error correction techniques are well know in analog to digital conversion and will not be described in detail herein. The use of error correction, or inclusion of other information regarding the measured intensities may change the number of bits in the bit sequence.

In this example, the seed (the 120 bits) is used to generate a 56 bit encryption key that is based on the Data Encryption Standard (DES) (step 166). Deriving a cryptographic key is a well-known technique to those of skill in the art so will not be described in detail herein; however, these details can be found in the “Handbook of Applied Cryptography”, by A. Menezes, P. van Oorschot, and S. Vanstone, CRC Press, 1996 or “Applied Cryptography” by Bruce Schneier, John Wiley & Sons, 1996.

Once the new cryptographic key is derived, the EKP module stores this new cryptographic key in RAM 92.

If a larger seed is required (that is, a seed with more bits), then multiple luminescence spectra can be measured and concatenated to form a larger seed. Various methods may be used to generate multiple different spectra. The following is an example of one of those methods, which is based on the decay rates of the luminescent emission from a rare earth ion at specific wavelengths. By measuring a spectrum after a first time has elapsed from de-activation of the emitter 102 and then measuring a spectrum after a second time has elapsed from de-activation of the emitter, two different spectra are obtained. It should be ensured that the first and second time periods are shorter than the decay time of the luminescence, otherwise only background luminescence will be recorded. The reason that two different spectra are obtained is that different transitions within the secure tag have different decay times, so that one transition may have a longer or shorter decay time than another. Each peak observed on a luminescence spectrum corresponds to one or more transitions, so the shape of the spectrum (that is, the intensity of each peak) will be different at different times during the luminescence decay process. If more than one rare earth ion is used in the secure tags, then each rare earth ion will typically have a different decay rate, which means that different transitions (peaks) in the luminescent spectrum resulting from illumination of the secure tag will decay at different times. This is because the decay rate of a transition depends on which rare earth ion is associated with that transition.

By measuring two different spectra, it is possible to create two 120 bit sequences, which can be concatenated to form a 240 bit sequence. This 240 bit sequence can then be used as a seed from which a cryptographic key can be derived. The skilled person will now realize that a large number of spectra can be recorded if a large seed is required. Furthermore, more samples from each spectrum (for example at every 5 nm) may be used.

It should also be appreciated that the number of different intensity levels for mapping should be selected so that the difference between adjacent amplitudes is not less than the noise contribution (electrical, thermal, and optical), otherwise the noise may shift the intensity by more than one amplitude level.

In the general case for this method, X different spectra are recorded. For each of the X spectra, intensity is measured at Y different wavelengths. For each of the Y different wavelengths, the intensity at that point is scaled with reference to a datum point and mapped to one of Z different intensity ranges. In the above example using a single luminescence spectrum, X is one, Y is forty, and Z is eight, yielding a 120 bit sequence for use as a seed; whereas in the above example using two luminescence spectra, X is two, Y is forty, and Z is eight, yielding a 240 bit sequence for use as a seed. In the general case, values for X, Y and Z can be chosen differently, and may be selected according to the rare earth dopant or dopants used in the secure tag. Similarly, the datum point may be different for each measured spectrum in a time-decay-based method of deriving a seed. The datum point may be based on the peak intensity, an intensity at approximately half of the peak intensity, or some other convenient intensity.

While the invention has been disclosed with respect to a limited number of embodiments, those skilled in the art will appreciate numerous modifications and variations therefrom. It is intended that the appended claims cover such modifications and variations as fall within the true spirit and scope of the invention.

For example, the time-decay method of deriving a seed for a key is only one of many methods that could be used to derive a seed. An alternative method for deriving a seed for a new cryptographic key is to use the old key to operate on the emission spectrum measured from the token presented to the reader. This could use a predetermined portion of the spectrum from the token (for example 500 nm to 600 nm), and a predetermined time delay, to generate a mini-key. This mini-key could then be used by the reader to operate on the concatenated intensity number derived from the token emission, and thereby generate a new key.

Some of the possible ways of deriving a new key include using: the old key, a time dependent algorithm, and/or a fixed algorithm.

It is also possible to have a method for confirming that the correct key has been generated. An additional code could be loaded into the token (for example, an integrated circuit card into which the rare earth tags are incorporated) and read by the EKP module 18. The EKP module 18 would apply the new key to the additional code and output a response. The response could be matched to information printed on the token, thereby allowing the person presenting the token to confirm the success of the key generation process.

In the above embodiment, the token reader is incorporated into the EKP module; in other embodiments, the token reader may be incorporated into the MCRW module (or another type of token reader that an ATM customer uses to identify himself or herself), thereby ensuring that the servicer does not have to open the fascia to load a new key.

In the above embodiment, the token is a card. In other embodiments, the token may be an I-button, a smart ring, a memory cell, or any other convenient token.

In the above embodiment, the card 104 is presented to the reader 84 by inserting it into the reader 84; in other embodiments a token can be presented to the reader by placing it in close proximity to the reader 84.

In the above embodiment, the secure tags comprise borosilicate glass particles doped with lanthanide ions; however in other embodiments different secure tags may be used, such as secure tags based on other chemicals. The secure tags may be in the form of quantum dots, a different luminescent pigment, or such like.

In the above embodiment, the attribute was based on luminescence; in other embodiments a different attribute may be used.

In the above embodiment, a DES key was derived from the seed value. In other embodiments, the seed value could be used to generate other cryptographic keys for many different cryptographic methods. Some examples of different cryptographic methods that can be used include methods based on asymmetrical (e.g., RSA, Diffie-Hellman, and El Gamal) and symmetrical (e.g., DES, Triple DES, and Rijndael Cipher) encryption. These cryptographic techniques are well know in the art and examples of these and others can be found in the “Handbook of Applied Cryptography”, by A. Menezes, P. van Oorschot, and S. Vanstone, CRC Press, 1996 or “Applied Cryptography” by Bruce Schneier, John Wiley & Sons, 1996.

In the above embodiment the luminescence of the token was stimulated by illuminating it, though in other embodiments the luminescence of the token may be stimulated with other forms of electromagnetic radiation (x-rays). In still other embodiments the luminescence may be stimulated by, a chemical reaction (chemoluminescence), temperature (thermoluminescence), a biological process (bioluminescence), or such like.

In other embodiments, the reader may require a token to be permanently presented to the reader to authorize the EKP module to use a cryptographic key already stored in memory. This has the advantage that a key is only released for use when the token is present. It also has the advantage that it is very difficult to ascertain which key is being used (when multiple keys are stored in the memory) because the key is referenced by the secure tag using an algorithm built into the token reader. Hence only by reading the tag can the key be released for use. If there is no token, then the EKP cannot access a key. The token may remain in place so that the key is made available and used on demand. This has the advantage that the key is never exposed within the EKP so that it cannot be captured by any of the conventional attacks on an EKP. This could remove the requirement for the tamper detection and key delete functions, since even if the EKP is compromised there is no way to access the key referenced by or derived from the token.

It would be possible to have multiple tags on the card for further validation, such as of a new key, since the previous key may have to be present to authenticate the new key. Using this system, added authentication is provided to avoid other keys being inserted either out of sequence or previous keys being used. Using a card based tag system there would also be a reduction in the manpower required to enter the keys into the ATM, since the tag is unreadable to anything but the tag reader one engineer could be provided with a stack of cards and update a number of ATMs without the keys ever being compromised.

Multiple key enablers on one token could also be used for updating other secure aspects of the ATM, such as verifying software downloads or updates. This would only permit engineers (or servicers) having the correct keys to install or validate new software, the key in the token would be used to verify a digital signature in the code which was generated when it was compiled. Again this would be secure since the software would only be installed if and when the correct key is presented, and the key cannot be reverse engineered or tampered with to allow other software to be installed.

The tags could be printed on the surface of the token if this was required—but an integral tag may be more secure. The tag could also be incorporated into a more complex or at least proprietary form, for example, one or more glass rods, or such like. This would make the reader even more secure since the form-factor of the token providing the key could not be fitted into other devices and damaged. It would also mean that the reader could be designed to securely capture the specific form-factor of the token.

In the above embodiment, the EKP is a PINpad (that is, it does not contain keys having a letter thereon, such as a conventional QWERTY keyboard). In other embodiments, the EKP may include more than sixteen keys; for example, over thirty keys may be provided, one key for each letter of the alphabet, plus function keys, numerical digits, and such like.

It will now be appreciated that the above embodiment, and/or the alternatives listed above, have the following advantages when applied to the secure distribution of encryption keys. These include: a significant man-power cost saving, because only one person is required for the secure distribution of keys to ATMs and EKPs. This could either be a service engineer or the tokens could be mailed to the ATM owner who could update the keys. The token cannot be read without the correct reader. The key may reside on the card and never be exposed within the EKP. This solution does not require anyone to type in digits for use in a key, so human error is reduced or obviated. The key that will be derived may be destroyed after manufacture so that it cannot be reverse-engineered. Tamper detection and key destroying mechanisms may not be required in the EKP, although they may still be used. The key can be applied to other high security applications, such as validation and authentication of software downloads of digitally signed software. The application of a token for resolving the issues of key distribution provides a very secure and simple method of distributing encryption keys.

What is claimed is:

1. A method of deriving a cryptographic key from a token comprising:
ascertaining an attribute of an emission from the token;
processing the attribute to generate a seed; and
deriving a cryptographic key from the seed.

2. A method according to claim 1, further comprising:
normalizing the attribute of the emission from the token prior to processing the attribute to generate a seed.

3. A method according to claim 1, wherein the attribute is luminescence intensity at each of a plurality of wavelengths, and wherein processing the attribute to generate a seed includes mapping each luminescence intensity to a corresponding binary code.

4. A method according to claim 1, wherein ascertaining an attribute of an emission from the token comprises:
exciting the token; and
detecting luminescence from the material in response to the excitation.

5. A method according to claim 1, wherein the attribute is obtained from the decay rate of the resulting emission.

6. An apparatus for deriving a cryptographic key comprising:
a reader adapted to ascertain an attribute of an emission from a token; and
a processor coupled to the reader and operable to: (i) process the attribute to generate a seed; and (ii) derive a cryptographic key from the seed.

7. An apparatus according to claim 6, wherein the processor is operable to process the attribute to generate a seed by:
normalizing the attribute; and
applying an algorithm to the normalized attribute to map the normalized attribute to a sequence of bits.

8. An apparatus according to claim 6, wherein the attribute is luminescence across a wavelength range, so that the attribute comprises a plurality of intensity values, one value for each wavelength used.

9. A self-service terminal incorporating an encrypting keypad, the terminal including a reader adapted to ascertain an attribute of an emission from a token; and a processor coupled to the reader and operable to: (i) process the attribute to generate a seed; and (ii) derive a cryptographic key from the seed.

10. A terminal according to claim 9, wherein the terminal includes a media dispenser.

11. An encrypting keypad comprising: a reader adapted to ascertain an attribute of an emission from a token; and a processor coupled to the reader and operable to: (i) process the attribute to generate a seed; and (ii) derive a cryptographic key from the seed, whereby the encrypting keypad is able to derive a new cryptographic key from a token presented thereto.
